(19) United States
(12) Patent Application Publication
(10) Pub. No.: US 2017/0287088 A1
(43) Pub. Date: Oct. 5, 2017

(54) BUYER BROKER REAL ESTATE REBATE SYSTEM

(71) Applicants: Carl Swanson, Algonquin, IL (US); Daniel Gurke, Crystal Lake, IL (US)

(72) Inventors: Carl Swanson, Algonquin, IL (US); Daniel Gurke, Crystal Lake, IL (US)

(21) Appl. No.: 15/085,635

(22) Filed: Mar. 30, 2016

(51) Int. Cl. G06Q 50/16; G06Q 30/02; G06Q 50/18

(52) U.S. Cl. CPC G06Q 50/167; G06Q 50/188; G06Q 30/0234

(57) ABSTRACT

A buyer broker real estate rebate system for purchasing and leasing real estate. The system utilizes property databases and provides an interactive purchasing broker for offering, negotiating and accepting terms; preparing a contract and closing package; and for rebating the buyer/seller.

### CROSS-REFERENCE TO RELATED APPLICATION

None.

### BACKGROUND OF THE INVENTION

I. Field of the Invention

The present disclosure relates generally to systems for providing realty services. More particularly, it relates to real estate purchasing and leasing systems that utilize property databases and provide an online interactive purchasing broker for offering, negotiating and accepting terms; for preparing a contract and closing package; and for rebating the buyer.

II. Description of the Prior Art

Traditional real estate services, and specifically those brokers representing a potential buyer and/or lessor, follow a well worn path. First, the buyer broker interviews the buyer client to determine his needs and assembles a list of properties that most closely meet those needs before touring the properties with the client. Next, the broker persuades the client to make a decision to extend an offer and then advocates/negotiates the offer on behalf of the client. After an agreement as to price (and perhaps other terms), the broker then reviews the contract with the client and his attorney. Finally, the transaction closes and the broker receives his commission check or, in the event of a lease, his invoice lease commission upon client occupancy.

Prior to online informational data bases, these traditional services worked well enough, as the Commercial Broker knew his market area, the listings, the buildings and the agents handling specific types of properties that best suited the client's needs. Newspapers typically had sections dedicated to commercial and industrial listings that were closely monitored by all the brokers. As for residential properties, the so-called Multiple Listing Services (MLS) was the only source, and the client needed to meet and work with the agent to access these listings.

With the arrival of online databases accessible to all, the exclusive control of listings by the broker/sales agent is now a thing of the past. In fact, there are now numerous publically accessible listing databases, some more inclusive than others, that enable buyers and sellers of real estate to search/narrow/choose properties that are clearer matches to their wants and needs. In essence, while a buyer's agent may still be able to provide limited assistance, the initial steps of locating a property of interest is now squarely in the buyer's hand.

With property databases so readily accessible, online systems and methods for selling and buying such properties were the next step in the realty evolution. In fact, there have been a plethora of systems developed that attempted to enhance the efficiency of real estate transactions via online automation. While many of these so-called virtual electronic broker systems have been launched, few have gained any real momentum, and most have simply just failed.

The failure of such virtual electronic broker systems is due to numerous reasons, not the least of which is the fact that the key players in the industry, realtors, mortgage brokers, and title companies, are generally fairly conservative, somewhat technically unsophisticated, and generally reluctant to embrace change, especially when such change likely decreases their own bottom lines. As a result, the players attempt to downplay such systems and keep the process shrouded in mystery.

Another reason these systems have failed is because they typically have been designed as all inclusive systems. In other words, the systems have attempted to guide buyers and sellers of real estate through the complete process of a real estate transaction, beginning to end, including but not limited to: listing the property; searching of listed properties; scheduling of property showings; evaluation of buyer credit worthiness; negotiating the terms of sale or lease; and providing all documents for closing—all over some form of communications and knowledge management network (i.e. internet). As such, with the automation of each step along the process, these systems inherently become more and more sophisticated and actually result in providing a more cumbersome system for buyers and sellers instead of a more simplified system.

Perhaps the biggest reason the prior art virtual electronic broker systems fail is that of finances. While these systems purport to make the process easier and more convenient for both buyer and seller alike, the typical commission formulas remain unchanged. In other words, as the brokers theoretically do less work for their clients under these virtual systems, they still receive the same amount of compensation. Naturally, if clients can do more of the process themselves online they do not want to have to pay the same amount of commissions as if their respective brokers had done it the traditional way, typically 6% of sale price. Obviously, such a scenario would make clients want to pay less. Accordingly, there exists a need for a virtual electronic broker system that utilizes some of the automation process of the internet while uniquely financially incentivizing the user.

It is therefore a general object of this disclosure to provide a system and method for addressing the deficiencies of the current practices regarding issues associated with virtual electronic broker systems.

It is another general object of this disclosure to provide a system and method that is simple, easy to use and familiar to internet users that would want to transact in real estate.

It is another general object of the present disclosure to provide a cost effective system and method of online real estate transactions.

It is more specific object of this disclosure to provide on online interactive purchasing real estate broker system and method.

It is yet another more specific object of this disclosure to provide an online interactive purchasing real estate broker system and method for rebating the buyer.

Yet a further more specific object of this disclosure is to provide an online interactive purchasing real estate broker system and method for incentivizing real estate attorneys and rebating the buyer of their services.

These and other objects, features and advantages of this disclosure will be clearly understood through a consideration of the following detailed description.

### SUMMARY OF THE INVENTION

According to an embodiment of the present disclosure, there is provided a broker real estate rebate system for rebating a portion of broker commission back to the user. The system utilizes a network service with a public and a private accessible portion upon registration. The service receives real estate property information and enables the user to create and send a letter of intent to the seller of the property. The seller can then initiate a negotiating process to either reject, accept or counter the offer of the letter of intent. Upon acceptance, the service creates a closing package, and upon closing, the system initiates payment of the rebate to the user.

There is also provided a method for automating a real estate transaction between a first party, a second party and a system administrator communicatively connected to a network. The method including registering with the service by the first party, entering real estate property information within the service by the first party, presenting a letter of intent for the first party to complete and presenting it to the second party. Negotiating the terms of the letter of intent between the parties, and, upon acceptance of terms, creating a closing package by the service provider. And, rebating a portion of the commission back to the first user by said service provider.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a screen shot of the initial homepage of the buyer broker real estate rebate system of the present disclosure.

FIG. 2 is a screen shot of the initial accessed page of the buyer broker real estate rebate system of the present disclosure.

FIG. 3a is a screen shot illustrating a property information data entry of the buyer broker real estate rebate system of the present disclosure.

FIG. 3b is a screen shot displaying the property details after entry in FIG. 3a.

FIG. 4a is a screen shot illustrating a buyer letter of intent offer of the buyer broker real estate rebate system of the present disclosure.

FIG. 4b is a screen shot displaying the sent offer of FIG. 4a.

FIG. 5 is a screen shot of the letter of intent of FIG. 4a wherein the seller can counter.

FIG. 6 is a screen shot of the letter of intent of FIG. 5 wherein the buyer can counter.

FIG. 7 is a screen shot displaying the offer acceptance of the letter of intent of FIG. 6.

FIG. 8 is a screen shot displaying the contract pending for the property of FIG. 4a.

FIG. 9 is a screen shot displaying the contract of FIG. 8 has been signed.

FIG. 10 is screen shot illustrating the clear to close procedure of an embodiment of the buyer broker real estate rebate system of the present disclosure.

FIG. 11a is a screen shot of the closing package of FIG. 10.

FIG. 11b is a screen shot of illustrating the prepared package of FIG. 11a.

FIG. 11c is a screen shot illustrating the complete package of FIG. 11a.

FIG. 12 is a simplified flow diagram of an embodiment of the process and method of the buyer broker real estate rebate system of the present disclosure.

FIG. 13 is a simplified flow diagram illustrating the negotiation process of an embodiment of the buyer broker real estate rebate system of the present disclosure.

FIG. 14 is an exemplar notification to the seller within the buyer broker real estate rebate system of the present disclosure.

FIG. 15 is an exemplar notification to the buyer within the buyer broker real estate rebate system of the present disclosure.

FIG. 16 is a screen shot illustrating the inline display of previous terms feature within the buyer broker real estate rebate system of the present disclosure.

### DESCRIPTION OF THE PREFERRED EMBODIMENTS

The following description of the preferred embodiments is merely exemplary in nature and is in no way intended to limit the disclosure, its application or use. These exemplars are merely used to better describe the true spirit and scope of the present disclosure.

The present buyer broker real estate rebate system allows users to easily navigate through the process of buying and/or leasing real estate and then receive a rebate of the purchase price upon completion of the process. More specifically, the buyer utilizes the system, and not a physical broker, to make an offer, negotiate and accept terms of the purchase and/or lease, prepare a contract and closing package, and most importantly—receive a percentage of the brokerage commissions as a rebate of the purchase/lease price at closing. It is important to note at the onset that this is a rebate of their own funds and therefore is not earned income and is not taxable.

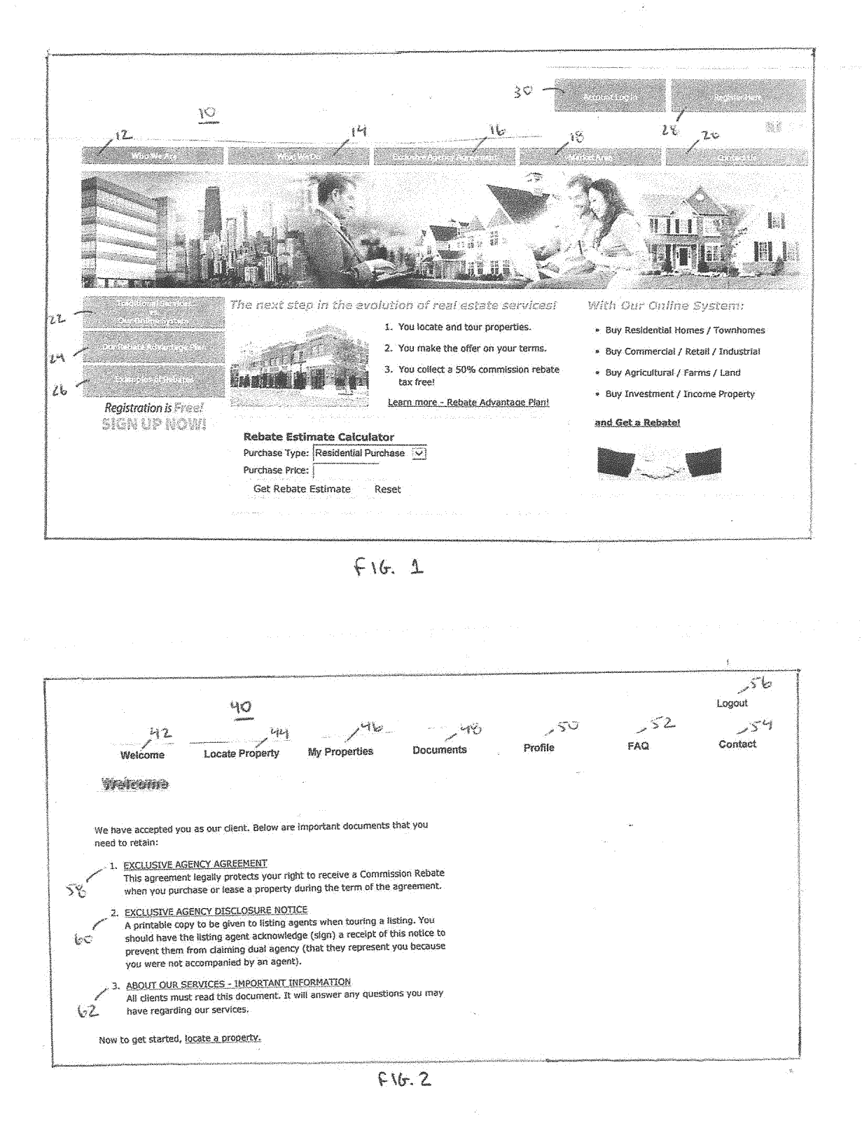

Turning now to the Figures, and in particular FIG. 1, a screenshot of an exemplar initial homepage 10 of the system is illustrated. This screenshot (and any further screenshots) may be a display from a personal computer (PC), laptop, tablet, television, smartphone, personal communication device (PCD) or any other device capable of displaying and/or providing information from the system servers through any network communication system (i.e. the internet). In any event, the homepage 10 is readily accessible by the general public and enables the user to access introductory and explanatory information through multiple actionable displays. Such information may be accessible via navigational icons, tabs, drop downs, links, and the like. By way of example, the homepage 10 may include icons for Who We Are 12, What We Do 14, Exclusive Agency Agreement 16, Market Area 18, and Contact Us 20. Further icons may include Traditional Services vs. Our Online System 22, Our Rebate Advantage Plan 24 and Examples of Rebates 26.

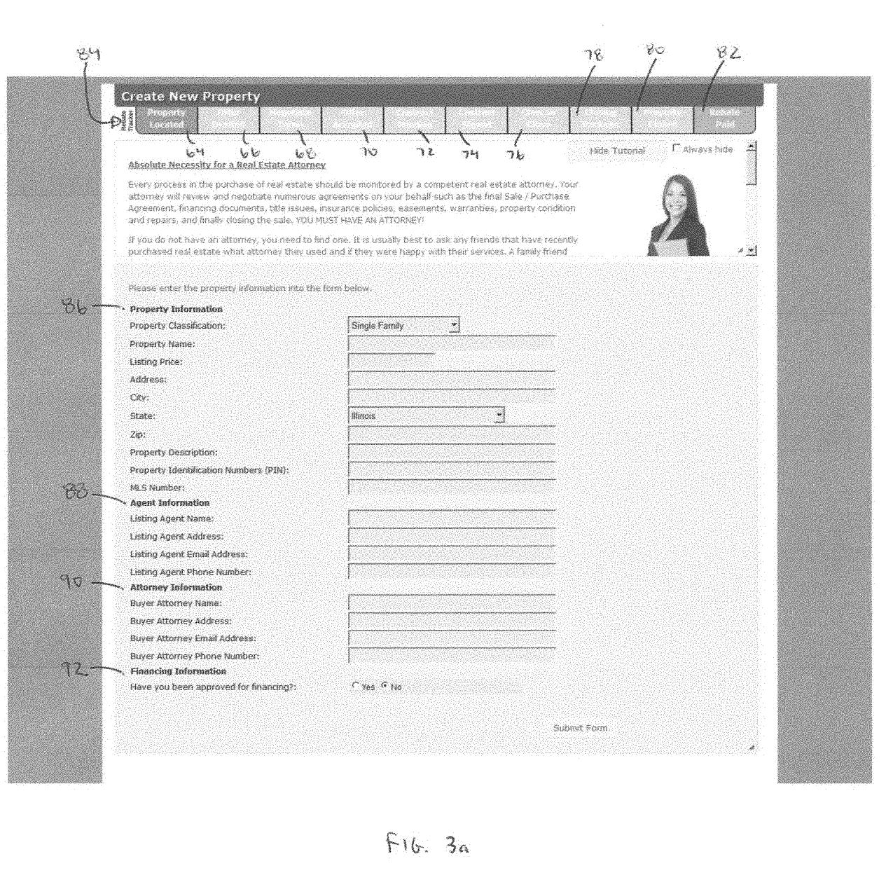

In order to gain access to the system services, the user must register 28 and agree to an exclusive agency agreement. Once the registration process is complete, which also includes general user and contact information as well as an account identification and password, the user is able to log in 30 to the system and access the services. FIG. 2 is illustrative of an exemplar initial accessed or welcome page 40 screenshot. This welcome page 40 includes Welcome 42, Locate Property 44, My Properties 46, Documents 48, Profile 50, Frequently Asked Questions 52, Contact 54 and Logout 56.

The Welcome tab 42 includes links to the Exclusive Agency Agreement 58, Exclusive Agency Disclosure Notice 60, and About Our Services 62. The Exclusive Agency Agreement 58 is the legal agreement between the service provider (the Buyer Broker) and the service user (the Buyer) and protects the right of the user to receive a commission rebate after purchase and/or lease of a property during the term of the agreement. The Exclusive Agency Disclosure Notice 60 is a printable notice that needs to be given to the listing agent for acknowledgement (via signature or otherwise). This Notice 60 prevents the listing agent from claiming dual agency due to the fact that the buyer was not physically accompanied by an agent.

The Locate Property tab 44 enables the user to search for any type of property (e.g. residential, commercial, agricultural, land/lot, etc.) via navigation through all publically available and MLS type listing services. The My Properties tab 46 enables the user to create properties to include in their collection or list of saved properties and also displays properties that have already been created. The Documents tab 48 may include, among other items, access to such information as user personal documentation, service documents, the Exclusive Agency Agreement, the Exclusive Agency Disclosure Notice, an offering price calculation worksheet, property check lists (for inspection), statement of rebate (for tax purposes) and W-9 information. The Profile tab 50 may include information about the user. The FAQ tab 52 displays frequently asked questions about the service and their customers. The Contact tab 54 provides the user with means by which to contact the service provider with any questions, comments or concerns. And, the Logout tab 56 navigates the user away from the services portion to the public portion of the system.

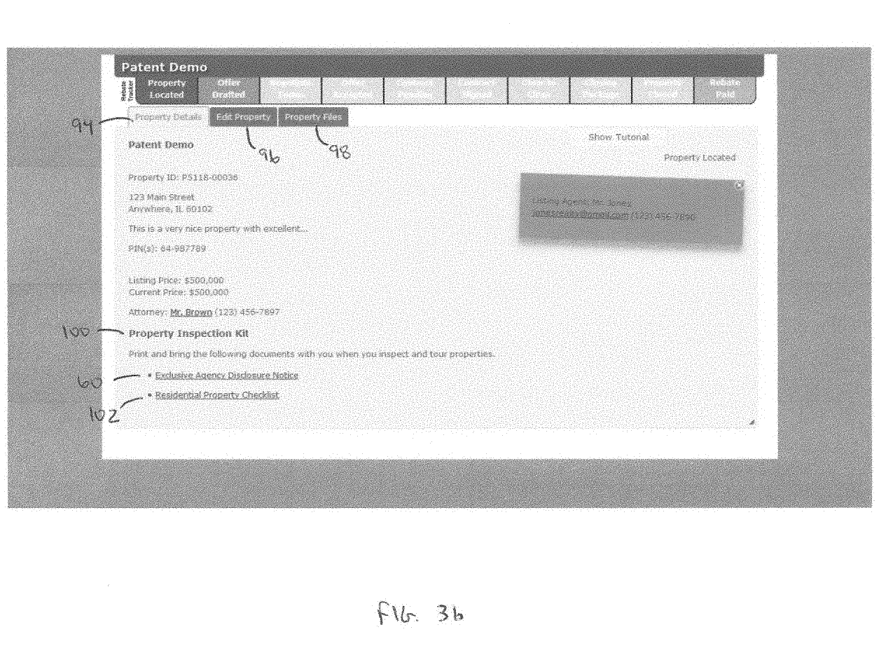

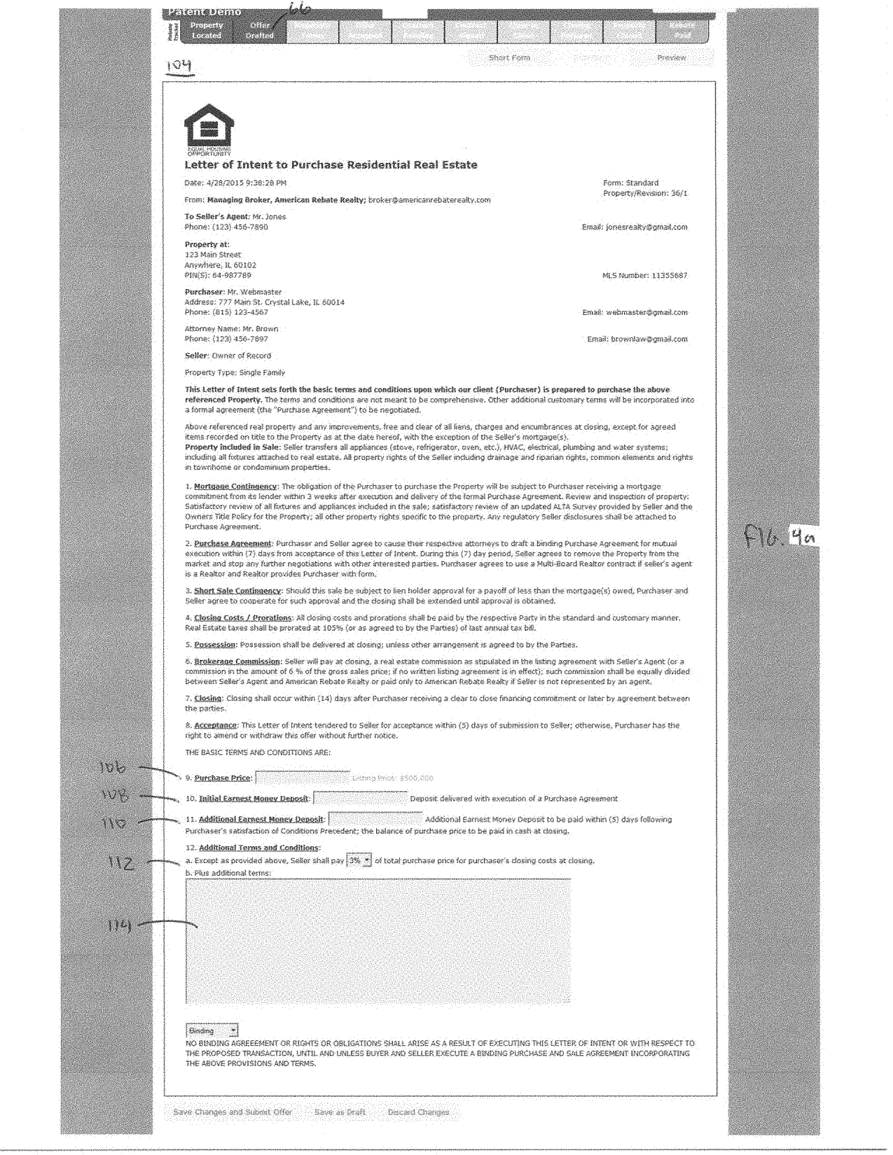

Once the user finds a property he is interested in, either through the Locate property tab 44 navigational links or otherwise, the My Properties tab 46 aides the user in initiating the buying and/or leasing process. In one embodiment of the present disclosure, the process consists of ten steps, and is presented as a drop down menu. In particular, and as illustrated in FIG. 3a, the process steps may include icons for Property Located 64, Offer Drafted 66, Negotiate Terms 68, Offer Accepted 70, Contract Pending 72, Contract Signed 74, Clear To Close 76, Closing Package 78, Property Closed 80, and Rebate Paid 82. These steps may be presented in a format by which progress through the process is easily identifiable, such as through a highlightable tracking method 84 or otherwise.

In order to begin the process, the property must first be located 64, and entered into the system. FIG. 3a depicts a property data entry format including Property Identification 86, Agent Information 88, Attorney Information 90, and Financial Information 92. FIG. 3b depicts the property details after such data entry. This screen provides the user the ability to quickly see the Property Details 94, to edit Property 96, and ascertain particular Property Files 98. A Property Inspection Kit 100 provides the user with links back to the exclusive Agency Disclosure Notice 60 and a Property Checklist 102 to bring along to property tours and inspections, respectively.

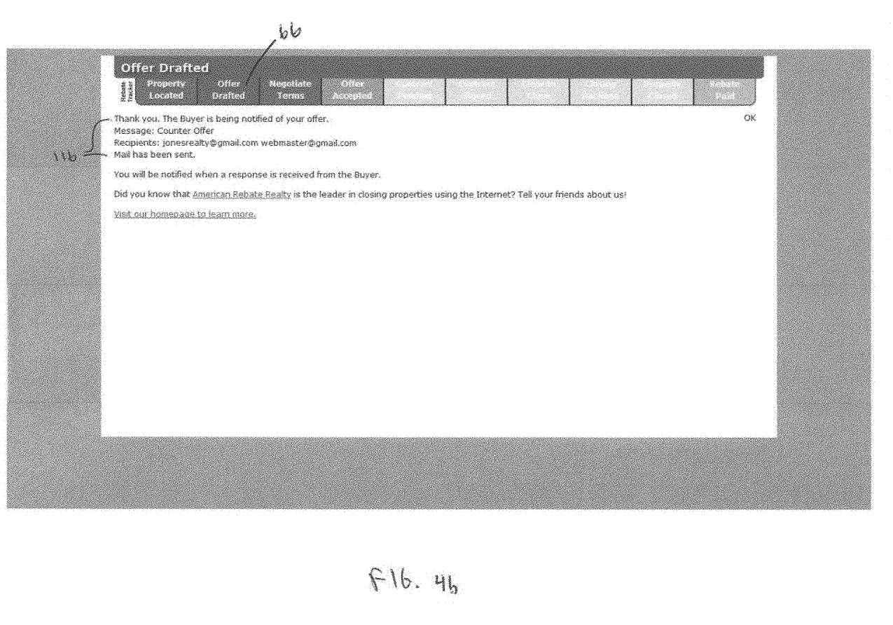

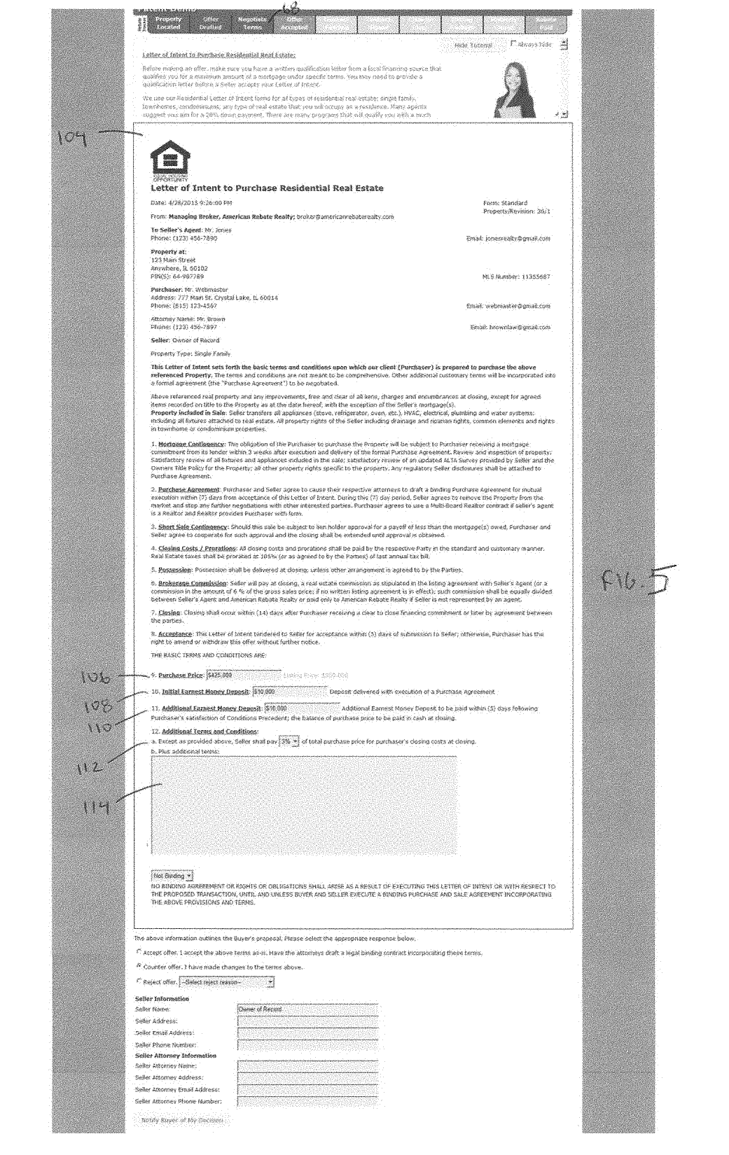

Once the user is ready to make an offer 66 for the property, he creates and provides a letter of intent (LOI) to the seller. Turning now to FIG. 4a, such a LOI includes all of the necessary legal information as well as the variable terms and conditions unique to these services. Such terms and conditions include Purchase Price 106, Initial Earnest Money Deposit 108, Additional Earnest Money Deposit 110, and perhaps a percentage of purchase price (to offset closing costs) to be paid by the seller 112 and other 114. Once complete, the LOI is presented to the seller and the user/buyer receives confirmation 116 of the offer—see FIG. 4b.

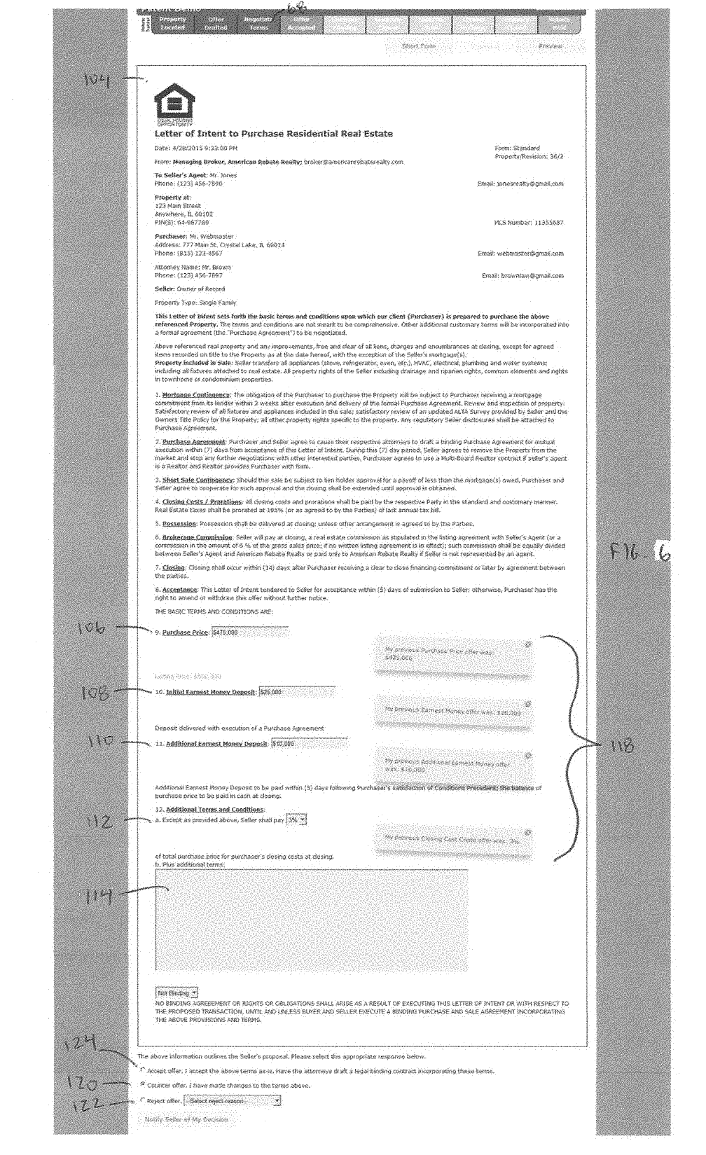

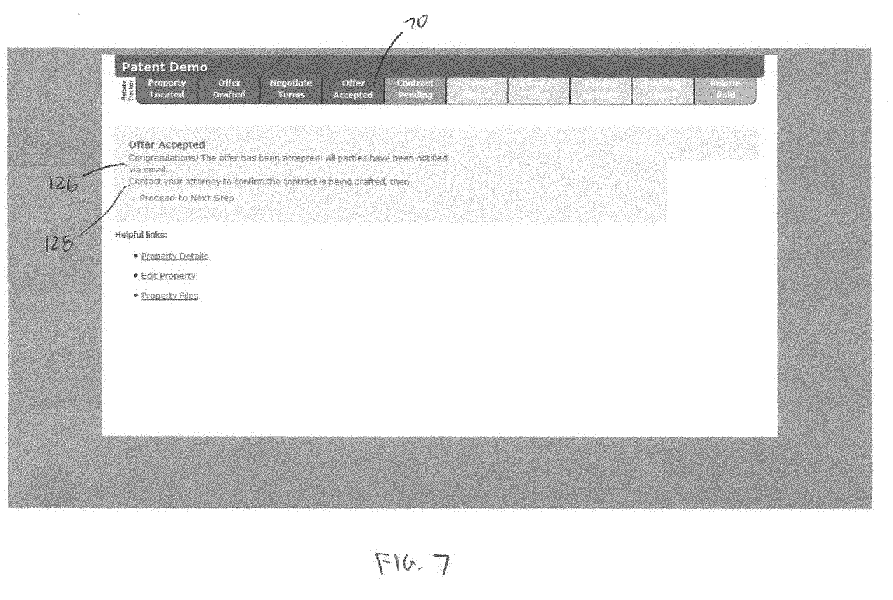

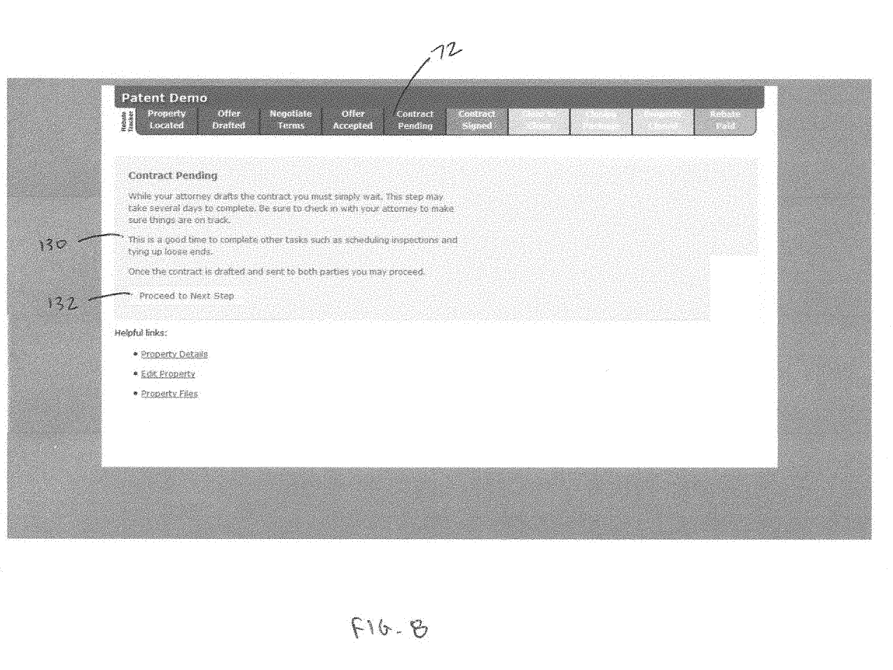

The seller of the property receives the LOI 104, see FIG. 5. The seller then has the opportunity to negotiate 68, should he so desire, and in particular, to accept, counter, reject or just ignore the variable terms and conditions (106, 108, 110, 112 and 114). If the seller counters any of the variable terms and conditions, the counter offer is then sent back to the user/buyer. Upon receipt of the LOI 104 counter, FIG. 6, the buyer then has the opportunity to negotiate 68, and in particular, to accept, counter, reject or ignore the variable terms and conditions (106, 108, 110, 112 and 114). This back and forth negotiation 68 between the user/buyer and the seller can continue indefinitely. With each transfer of the LOI 104, the respective previous values of the user/buyer and the seller, respectively, variable terms and conditions, are noted via pop up notes (reminders) 118. The countering 120 continues until offers are rejected 122, accepted 124 or simply ignored. If accepted 70, all terms and conditions are locked, and all parties are notified 126—see FIG. 7. The user is then prompted 128 to remind his attorney about the ensuing contract to sell or lease the property.

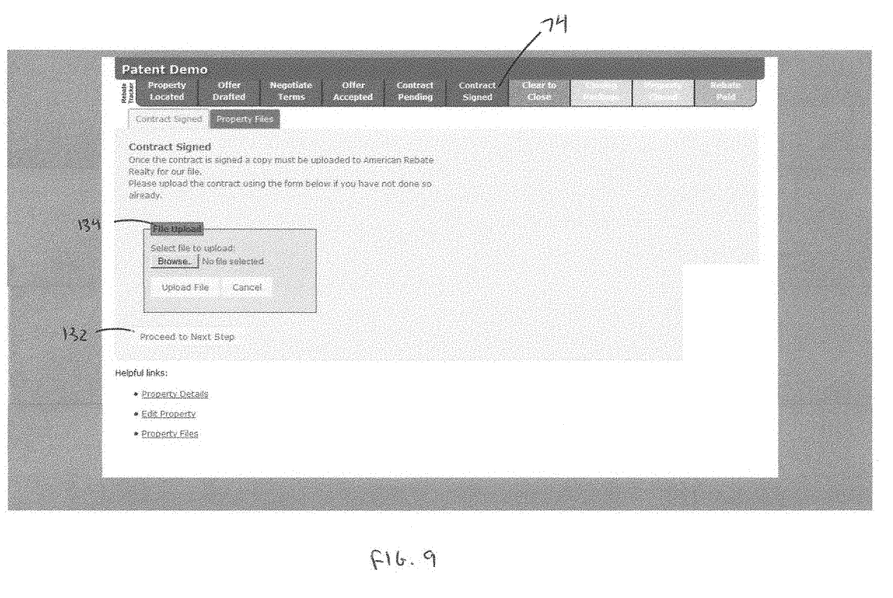

While the contract is pending 72, the user is prompted to complete other tasks 130 that may be involved, such as the scheduling of inspections and other loose ends—see FIG. 8. The user can only proceed to the next procedural step, via button actuation 132 for example, after the contract has been drafted and presented to both sides.

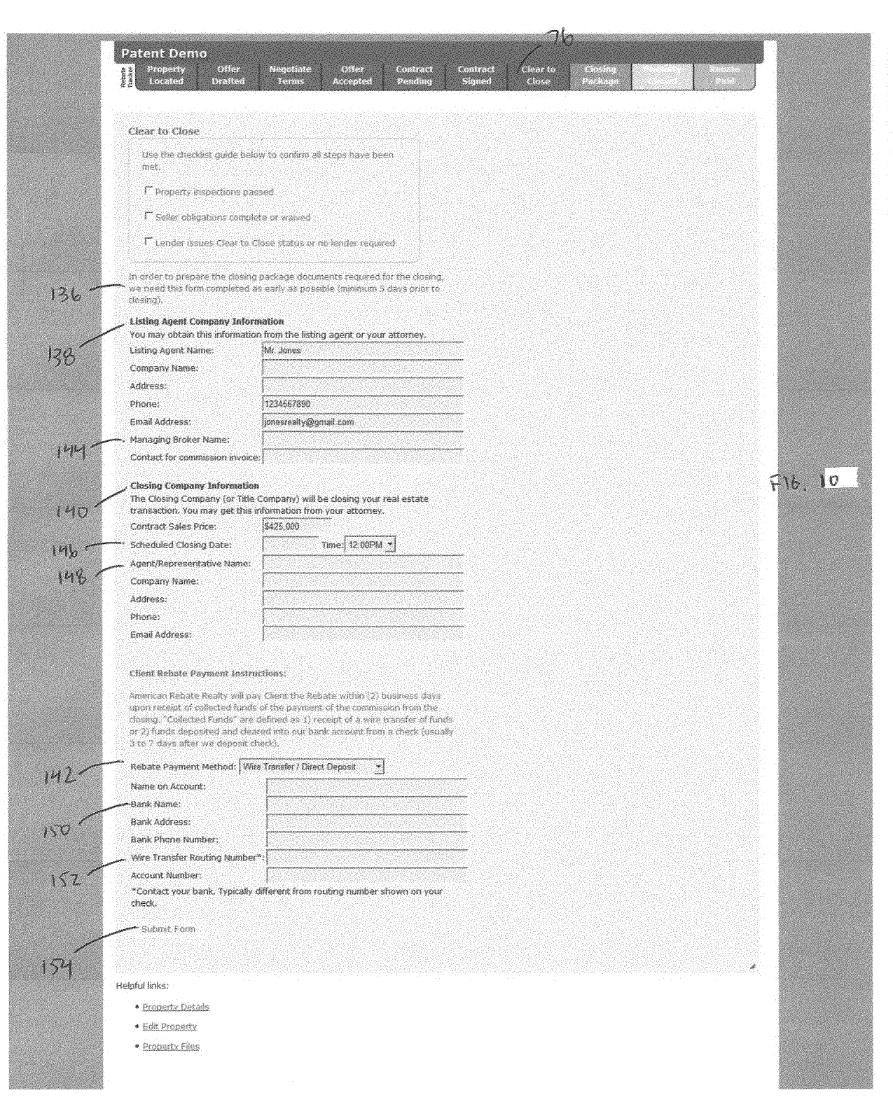

Turning now to FIG. 9, once the contract has been duly signed 74 it is uploaded to the system 134. The system administration then reviews the contract and the user can proceed 132 to the next procedural step.

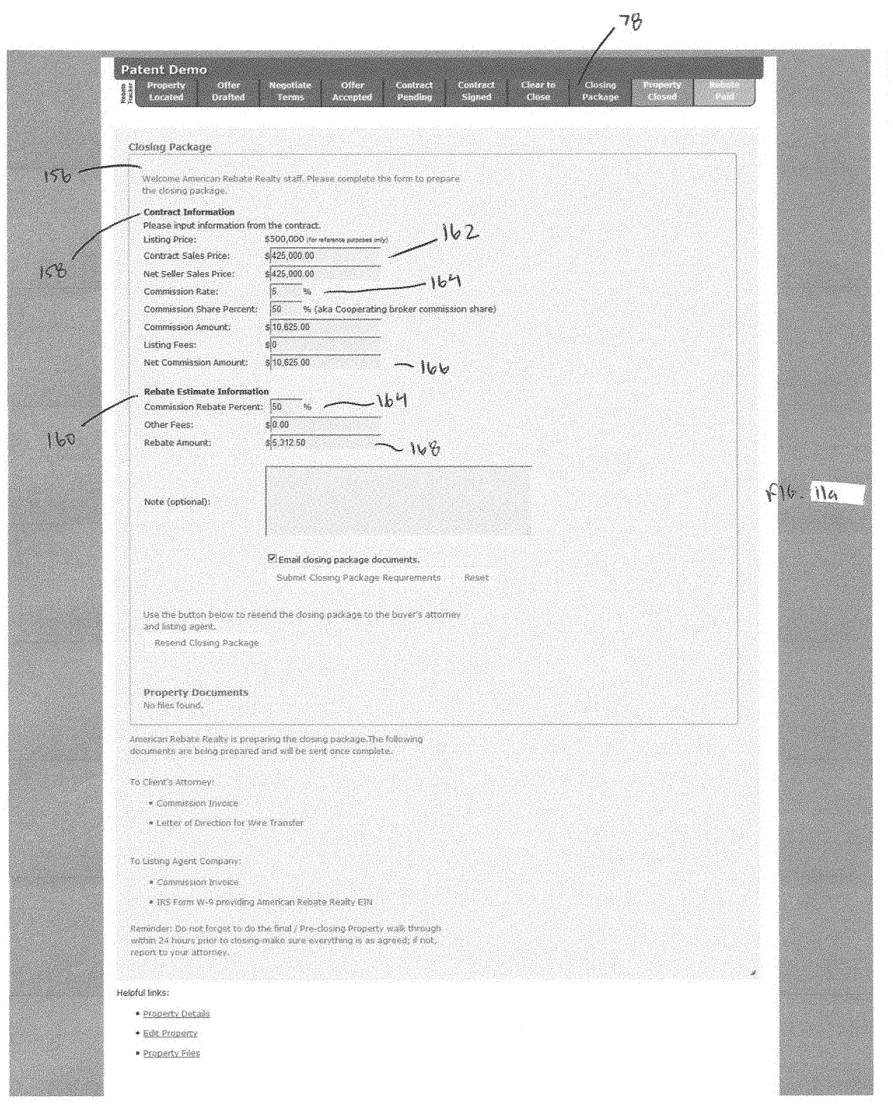

When the transaction is Clear To Close 76, FIG. 10, the user is prompted to enter all of the information into the system to enable preparation of the closing package documents. Such information may include Listing Agent Information 138, Closing Company Information 140 and Client Rebate Payment Instructions 142. The Listing Agent Information 138 may include, among other things, the managing broker name for invoicing purposes. The Closing Company Information 140 may include, among other things, the closing date 146 and the representative name 148. And, the Client Rebate Payment Instructions 142 may include, among other things, the name of the bank 150 and the bank account wire transfer routing number 152. Once all of the necessary information has been entered, the user submits 154 the form.

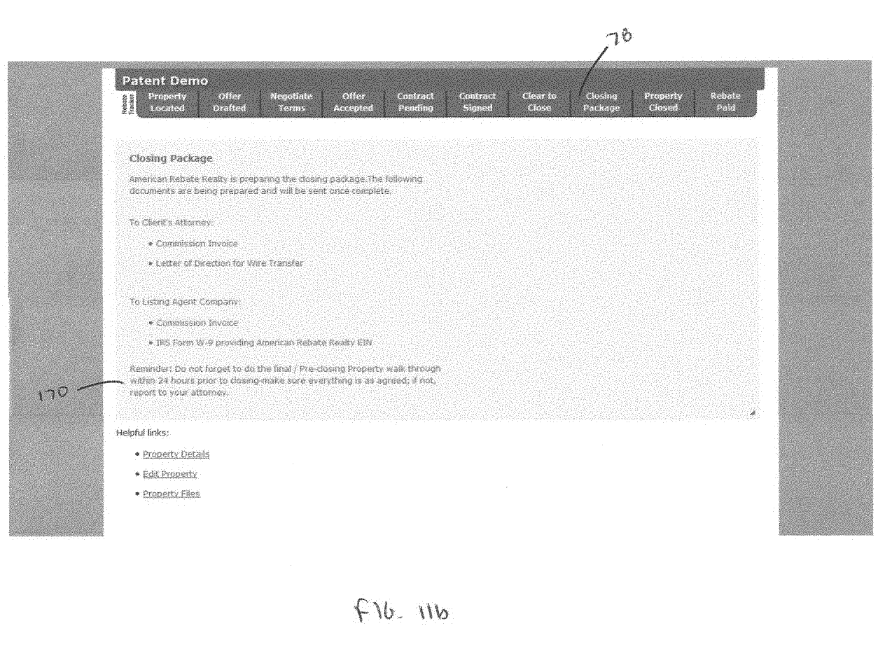

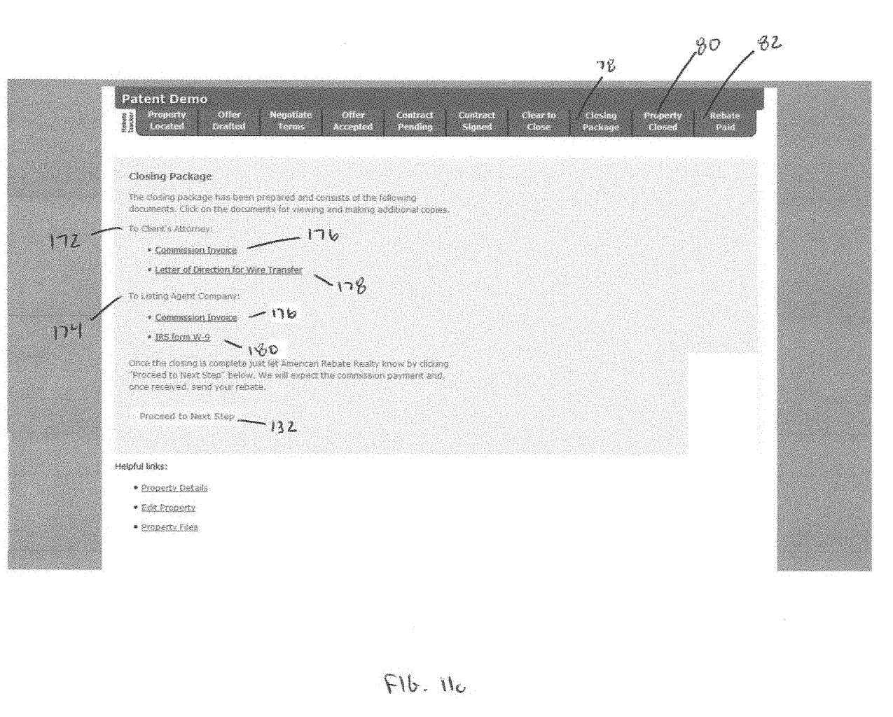

FIGS. 11a-11c illustrate an embodiment of the closing package 78 process of the present disclosure. Referring first to FIG. 11a, the system administration completes a closing package form 156 which may include the Contract Information 158 and the Rebate Estimate Information 160. The Contract Information 158 includes, among other things, the sales price 162, the commission rate 164 and the net commission amount 166. The Rebate Estimate Information includes, among other things, the commission rate 164 and the rebate amount 168.

While the system is completing the closing package form 156 of FIG. 11a, the user is notified thereof—see FIG. 11b. Here the user is reminded 170 to schedule the final pre-closing walk through. Once the closing package is complete, the documents are generated and delivered to the user/buyer and attorney 172 and listing agent 174, see FIG. 11c. The client (user/buyer) and attorney documents may include, among other things, the commission invoice 176 and a letter of direction for wire transfer 178. The listing agent documents may include, among other things, the commission invoice 176 and an IRS form W-9 180. After the transaction has closed 80, the user notifies the system by activating the Proceed to Next Step icon 132. The system administration may then congratulate the user while it internally generates and completes all necessary commission and rebate calculations and forms. The system administration then waits for the commission payment, and once received, rebates 82 the user/buyer, and may once again congratulate the user, provide him with any necessary forms and/or statements, and the process is complete.

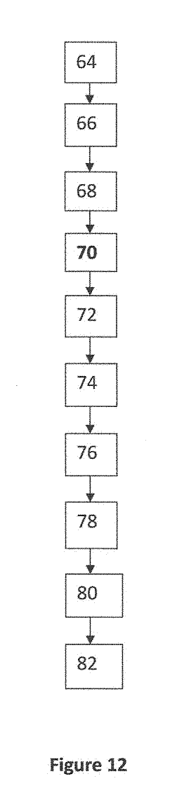

Thus far, the present disclosure has been shown and described with a focus on the user/buyer interaction through PCs, PCDs and the like. The system and method will now be described through the use of some logic flow and process diagrams, as well as some further exhibits, to further illustrate the processes. In particular and turning now to FIG. 12, an exemplar ten step process is stepped through. More specifically, the REBATE TRACKER™ 84 process is stepped through wherein a property is located 64, an offer is drafted 66, terms are negotiated 68, the offer (or counteroffer) is accepted 70, a contract is pending 72, the contract is signed 74, the deal is clear to close 76, a closing package is prepared 78, the property closes 80 and the rebate is paid 82. Each step of the process inserts some data into the database and/or increments the property status ID to the corresponding stage number. Some steps are incremented through automation, some by user/buyer, some by seller and some by the system administrator.

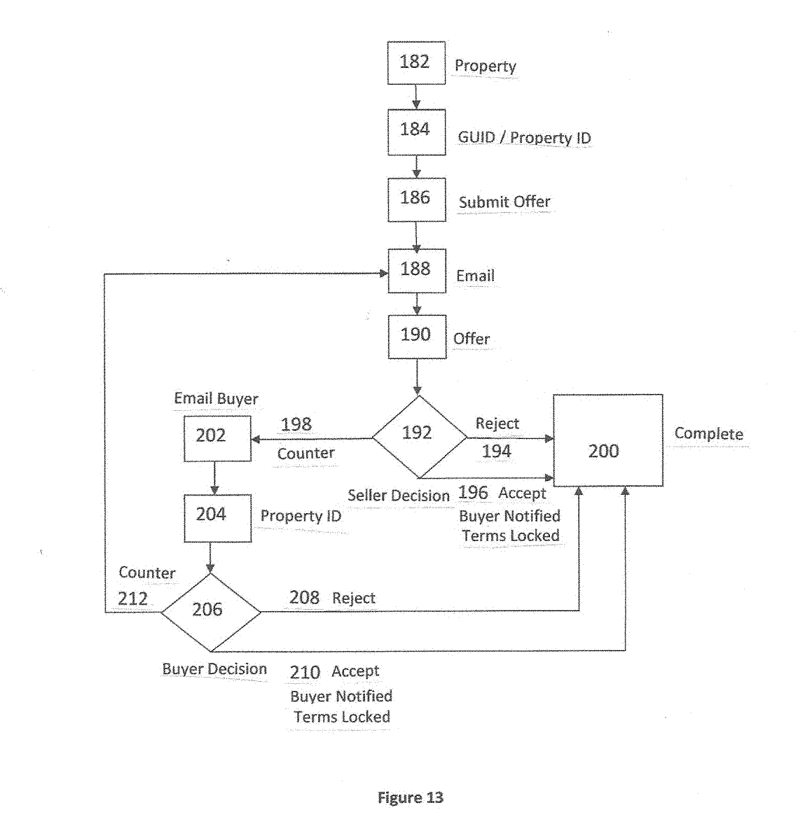

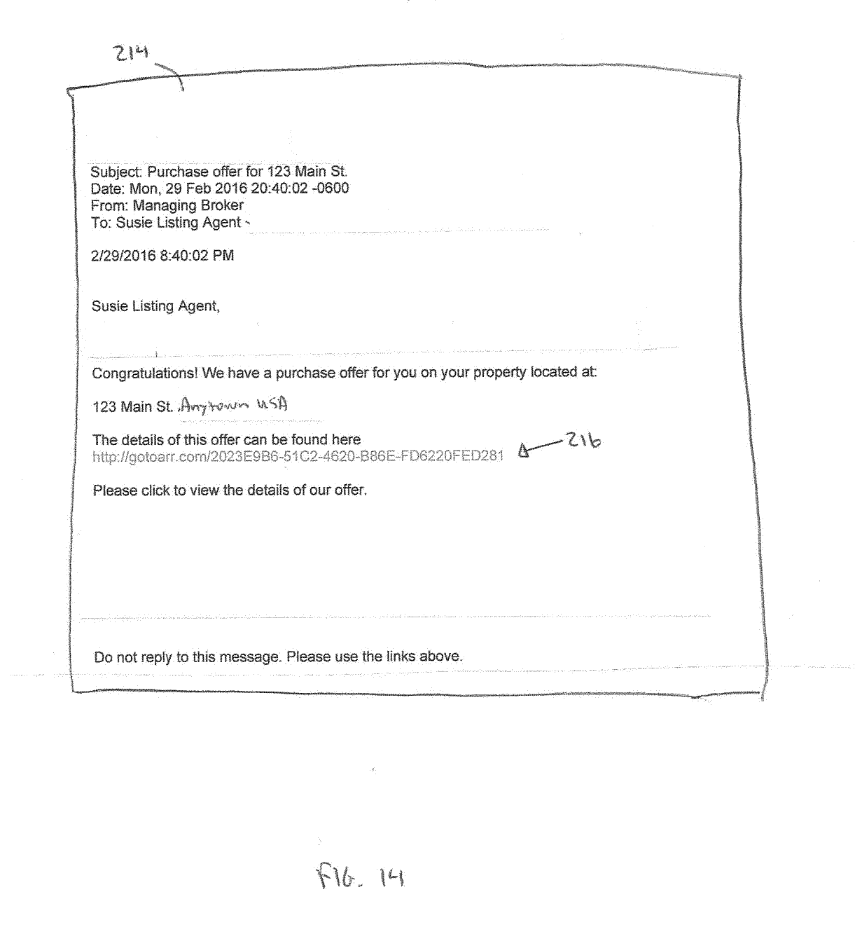

FIG. 13 more particularly illustrates the negotiation steps of the present disclosure. In particular, the system user (i.e. buyer) creates a property 182 and the system creates a Globally Unique Identifier (GUID) associated with the property, together with a Property Identifier (PropID) 184. When the buyer submits an offer 186, the system sends notification (e.g. email) 188 to the seller with the GUID in the network Uniform Resource Locator (URL). When the seller enables (i.e. selects, clicks, etc.) the URL he is automatically logged into the application via the GUID and is presented with the offer 190. The seller then has a decision to make 192 and can either reject 194, accept 196 or counter 198. If he rejects 194, the negotiation is complete 200. If he accepts 196, the buyer is notified (e.g. email) with PropID in the URL and the terms are locked in the system and the negotiation is complete 200. If he counters 198, the system sends notification (e.g. email) 202 to the buyer with the PropID in the URL. When the buyer enables the URL he is presented with the counteroffer via the PropID 204. The buyer then has a decision to make 206 and can either reject 208, accept 210 or counter 212. If he rejects 208, the negotiation is complete 200. If he accepts 210, the seller is notified (e.g. email) with same GUID URL and the terms are locked in the system and the negotiation is complete 200. If he counters 212, the system sends notification (e.g. email) 188 to the seller with the GUID in the URL, and he enters the negotiation process again. This negotiation feature simplifies seller experience of reviewing and responding to a real estate property offer by alleviating the requirements of the seller to identify himself through a traditional username and password, instead having immediate access to the buyer's secure offer. This also solves the problem of using a unique GUID for each email transmission. This approach of a single property GUID is not only more secure, but allows the seller to always view the current “real-time” offer and not an offer that may have been superseded, regardless of which email link was used. The PropID also represents the “real-time” offer. Historical offers are made available to both parties through a revision token.

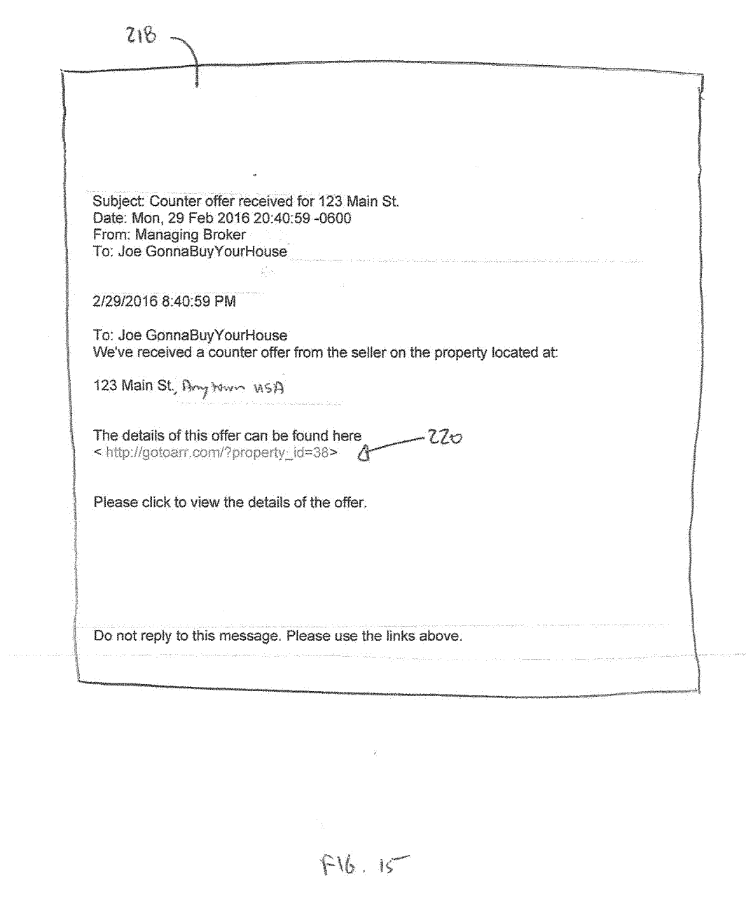

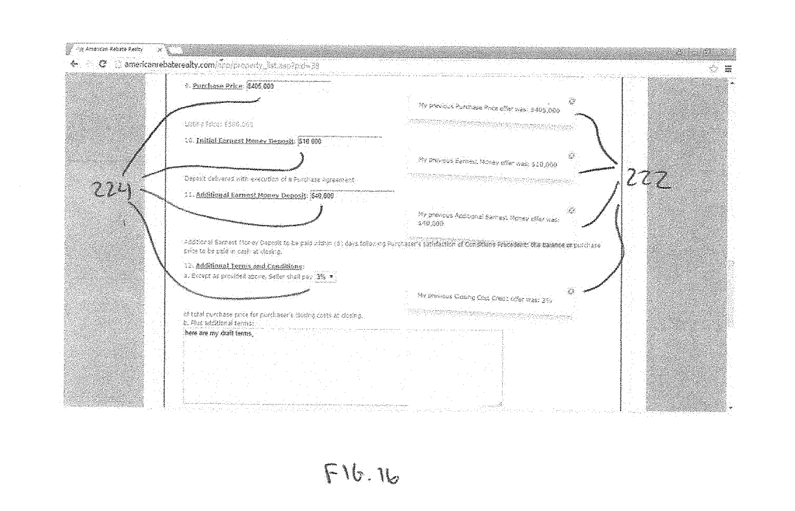

Turning away from the process of FIG. 13, and back to the user experience of the negotiations, FIG. 14 illustrates an exemplar email 214 sent to the listing agent with URL including GUID 216. This URL allows the listing agent and seller to access the authenticated area of the website without providing authentication aside from the GUID. In other words, the listing agent and/or seller is not burdened with having to create or provide a username or password, but simply clicks a link in the email to view the real estate purchase offer via the LOI and is able to instantly respond. This GUID also allows previous emails to always visit the current state of the property, no matter which link is clicked, alleviating user confusion. The buyer and seller may counter the offer, and if so, steps above are repeated with inverse notification of the other party. To that end, FIG. 15 illustrates an exemplar email 218 sent back to the buyer with URL including PropID 220. This may repeat perpetually whereby each round inverts the mechanic of direction to buyer or seller of the login tokens. Each parties respectful “previous terms” are displayed (for example as postable notes, see FIG. 16) beside the current offer for reference purposes. The buyer is unable to view the “seller side” (and vice versa) because of the use of the GUID being sent only to the seller and cannot accept an offer.

This inline display of previous terms feature in once again illustrated within FIG. 16. This feature allows the viewer of the real estate offer to see the last term of each field in the contract 222, next to the current term 224, displayed as a collapsible reminder. It solves the problem of knowing what the last offer was, before the other party's counteroffer. Giving constant reminder of position on terms of the contract. This is especially helpful when doing multiple offers concurrently and alleviates the need to keep referring back to previous contract copies. During the enumeration of the contract fields, each field is compared to the previous value submitted and both values are displayed. The “current” value being shown and the “previous” value, if any, is displayed as a collapsible reminder note. While the contract itself is printable, the reminder notes are not sent to the print engine.

This offer authentication and party inversion scheme is an integral part of the buyer broker system. The backend software subroutines that invert the buyer and seller and/or their respective authentication schemes appropriately, simplifying the code to use one subroutine for both buyer and seller responses. These functions provide a framework which allows more complex subroutines that encompass all the heavy lifting of the application while relying on these subroutines to invert the buyer/seller for responses and events. Alternatively, without their use, each workhorse routine will need to be coded twice, once for the buyer and once for the seller which introduces a higher potential for software errors and/or bugs and make code manageability unnecessarily complex.

Such a rebate system as described herein may also be utilized for other industries/services, either incorporated within real estate transactions or wholly separate. One example of this is an attorney rebating system.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A broker real estate rebate system for rebating a portion of broker commission back to the user, the system comprising:
a network accessible administrative service providing a public accessibility and a private accessibility, wherein said user is provided private access after registration with said service;
said service receives information entered by said user for one or more real estate properties;
said service provides a letter of intent with variable terms, including price, for said user to complete for a selected property, and sends said complete letter of intent to a seller of said property;
said service presents said letter of intent to said seller thereby initiating a negotiation process whereby said seller can reject, accept or counter said letter of intent;
said service creates a closing package upon acceptance of terms, said package including contract information; and
upon user notification of closing of said property, said system initiates payment to said user of said rebate.

2. The system of claim 1 wherein said service is capable of providing user access to property databases.

3. The system of claim 1 wherein said user registration includes an exclusivity agreement with a system administrator.

4. The system of claim 1 wherein said variable terms further include at least one of initial earnest money, additional earnest money, and percentage of purchase price.

5. The system of claim 1 wherein said negotiation process includes displaying of previous term values.

6. A method automating a real estate transaction between a first party, a second party and a service provider communicatively connected to a network comprising:
registering with said service by said first party;
entering real estate property information within said service by said first party;
providing an offer with variable terms, including price, for said property, whereby said first party completes said terms;
presenting said offer to said second party;
negotiating said variable terms of said offer between said first and said second party;
creating a closing package by said service provider upon acceptance of said terms; and
rebating a portion of a commission back to said first party by said service provider.

7. The method of claim 6 further comprising:
creating a globally unique identifier associated with said property.

8. The method of claim 7 wherein the globally unique identifier is provided in a uniform resource locator while providing the offer to said second party.

9. The method of claim 8 wherein said second party gains access to said negotiation via the globally unique identifier in the uniform resource locator.
